(19) United States
(12) Patent Application Publication
(10) Pub. No.: US 2017/0090453 A1
(43) Pub. Date: Mar. 30, 2017

(54) NUMERICAL CONTROLLER FOR CONTROLLING COLLISION POSITION OF CUTTER TIP OF TOOL AND WORKPIECE

(71) Applicant: FANUC CORPORATION, Minamitsuru-gun (JP)

(72) Inventor: Katsuhiro Endou, Minamitsuru-gun (JP)

(73) Assignee: FANUC CORPORATION, Minamitsuru-gun (JP)

(21) Appl. No.: 15/279,877

(22) Filed: Sep. 29, 2016

(30) Foreign Application Priority Data
Sep. 30, 2015 (JP) 2015-193278

(51) Int. Cl. G05B 19/29; B23C 3/00

(52) U.S. Cl. CPC G05B 19/29; B23C 3/00; B23C 2220/60; G05B 2219/35101; G05B 2219/49172

(57) ABSTRACT

A tool center path is compensated so that the number of collisions with a workpiece in positions on cutter tips complies with use frequencies in cutter tip information, based on tool information including the diameter of a tool and the number of cutter tips attached to the tool, a tool center movement path specified by a machining program, workpiece shape data, and cutter tip information.

### BACKGROUND OF THE INVENTION

Field of the Invention

The present invention relates to a numerical controller, and more particularly, to a numerical controller for controlling a collision position of a cutter tip of a tool and a workpiece.

Description of the Related Art

In rough machining or the like in face milling, if an engage angle at which a cutter tip engages a workpiece is too large, the thickness of chips produced when the cutter tip engages the workpiece is reduced, so that the workpiece is elastically deformed. Accordingly, a large force is applied to the nose of the cutter tip, thereby easily causing chipping. If the engage angle is too small, in contrast, the thickness of chips produced when the cutter tip engages the workpiece increases, so that the cutter tip is more shocked. Thus, chipping also occurs easily. In order to extend the tool life, therefore, it is necessary to program a tool center path in consideration of the engage angle to be confined within an appropriate range in which chipping cannot easily occur.

Conventionally, some techniques have been proposed to reduce wear and damage to cutter tips of tools. In a method disclosed in Japanese Patent Application Laid-Open No. 2003-170333, for example, a feed path is formed such that the maximum chip thickness of a chip portion produced by a tool before cutting and an arc length of cutting engagement are constant throughout the feed path. Thus, according to this method, wear and damage to cutter tips are reduced by keeping the cutting resistance constant. In machining methods disclosed in Japanese Patent Applications Laid-Open Nos. 2005-050255, 2003-263208 and the like, moreover, the cutting resistance and feed rate are kept constant by forming a tool path such that the engage angle can be kept constant. Further, there are disclosed methods in which the cutting resistance is detected to control the feed rate and spindle speed (Japanese Patents Nos. 4568880, 4923175, etc.) and methods in which the feed rate and spindle speed are controlled to keep the cutting resistance constant (Japanese Patent Applications Laid-Open Nos. 2002-233930, 2004-330368, etc.).

In these disclosed conventional methods, wear and damage to the tool are suppressed by simply keeping the cutting resistance and feed rate constant. According to these conventional techniques, the tool cutter tips and the workpiece can engage (or collide) in satisfactory positions without making the above-described engage angle too large or too small.

In some cases, however, chipping of the cutter tips cannot be prevented even with use of the conventional techniques. FIG. 18 shows an example of machining in which the cutting resistance is kept constant by standardizing a feed amount per blade. In this example, a point Pn at which a workpiece and a cutter tip of a tool collide with each other is in a specific position on the cutter tip. In some cases of such machining, the position in which the workpiece collides with the tool cutter tip is fixed, so that the force of collision may be concentrated on the specific position on the cutter tip, possibly causing chipping of the cutter tip.

### SUMMARY OF THE INVENTION

Accordingly, the object of the present invention is to provide a numerical controller capable of suppressing the occurrence of chipping due to concentration of a force produced by collision between a cutter tip of a tool and a workpiece at the time of rough machining or the like in face milling.

According to the present invention, a numerical controller is provided with a means for compensating a programmed tool center path based on tool information, shape information on a workpiece, and ranges and frequencies of use of a cutter tip and a means for compensating the tool center path based on a spindle load current and a pre-specified tolerance of the spindle load current.

A numerical controller according to the present invention controls a machine, which is configured so that a workpiece and a tool are relatively moved for machining by a drive mechanism and a spindle for rotating the tool, based on a machining program for specifying a movement path of the center of the tool. The numerical controller comprises a tool storage unit configured to store tool information including the diameter of the tool and the number of cutter tips attached to the tool, a cutter tip information storage unit configured to store usable ranges of the cutter tips and use frequencies in positions within the usable ranges of the cutter tips, a workpiece shape data storage unit configured to store workpiece shape data indicative of a shape of the workpiece, and a compensation unit configured to generate a compensated tool path, which is a compensated version of the tool center path, so that the number of collisions with the workpiece in positions on the cutter tips complies with the use frequencies, based on the tool information, the tool center movement path specified by the machining program, the workpiece shape data, and the cutter tip information.

The numerical controller may further comprise an engage angle information storage means for storing engage angle information including usable ranges of engage angles at which the cutter tips collide with the workpiece and use frequencies at the engage angles within the usable ranges thereof, and the compensation unit may be configured to generate a compensated tool path, which is a compensated version of the tool center path, so that the number of collisions with the workpiece at the engage angles of the cutter tips complies with the use frequencies, based on the tool information, the tool center movement path specified by the machining program, the workpiece shape data, and the engage angle information.

The numerical controller may comprise a spindle load current tolerance storage unit configured to store a spindle load current tolerance, which is a maximum allowable value of a spindle load current during cutting, and a spindle load current value during actual machining along a compensated tool path obtained by compensation by the compensation unit may be acquired such that the spindle load current value and the spindle load current tolerance are compared and the compensated tool path is further compensated based on the result of the comparison.

According to the present invention, a force produced by collision between a cutter tip of a tool and a workpiece at the time of rough machining or the like in face milling is prevented from being concentrated on a specific position on the cutter tip so that the occurrence of chipping due to force concentration can be suppressed.

### BRIEF DESCRIPTION OF THE DRAWINGS

The above and other objects and features of the present invention will be obvious from the ensuing description of embodiments with reference to the accompanying drawings, in which:

FIG. 1 is a diagram illustrating compensation of a tool center path in face milling according to an embodiment of the present invention;

FIG. 2 is a schematic configuration diagram of a numerical controller according to the present embodiment;

FIG. 3 is a diagram illustrating tool information on a tool with a cutter tip;

FIG. 4 is a diagram illustrating cutter tip information;

FIG. 5 is a diagram illustrating parameters for cutting in the face milling by the tool;

FIG. 6A is a diagram illustrating a lower end position for compensation in a tool center position;

FIG. 6B is a diagram illustrating an upper end position for the compensation in the tool center position;

FIG. 7 is a diagram illustrating a compensation range for the tool center position;

FIG. 8 is a diagram illustrating compensation points according to the embodiment of the present invention;

FIG. 9 is a flowchart showing processing performed on the numerical controller according to the embodiment of the present invention;

FIG. 10 is a flowchart showing processing performed on the numerical controller according to the embodiment of the present invention;

FIG. 11 is a diagram illustrating a table stored with compensation points and positions on the cutter tip according to the embodiment of the present invention;

FIG. 12 is a schematic configuration diagram of a numerical controller according to the embodiment of the present invention;

FIG. 13 is a diagram illustrating a compensation method according to the embodiment of the present invention;

FIG. 14 is a diagram illustrating a compensation method according to the embodiment of the present invention;

FIG. 15 is a diagram illustrating a tolerance of a spindle load current;

FIG. 16 is a schematic configuration diagram of a numerical controller according to the embodiment of the present invention;

FIG. 17 is a flowchart showing processing performed on the numerical controller according to the embodiment of the present invention; and

FIG. 18 is a diagram illustrating a conventional technique.

### DETAILED DESCRIPTION OF THE PREFERRED EMBODIMENTS

This application is based upon and claims the benefit of priority from the prior Japanese Patent Application No. 2015-193278, filed Sep. 30, 2015, the entire contents of which are incorporated herein by reference.

An embodiment of the present invention will now be described with reference to the accompanying drawings.

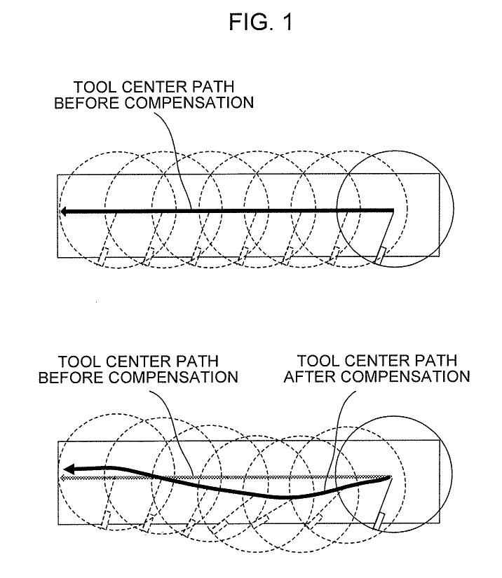

In face milling using a tool with a cutter tip, according to the present embodiment, the position of the tool is compensated perpendicularly relative to a programmed tool center path so that collision positions of the cutter tip and a workpiece are not concentrated to specific positions on the cutter tip, as shown in FIG. 1.

According to the present embodiment, there is provided a numerical controller in which a tool path such that the collision positions of the cutter tip and the workpiece are not concentrated to specific positions on the cutter tip is generated based on information on the tool with the cutter tip used for face milling, shape information of the workpiece, and information on the working range of the cutter tip.

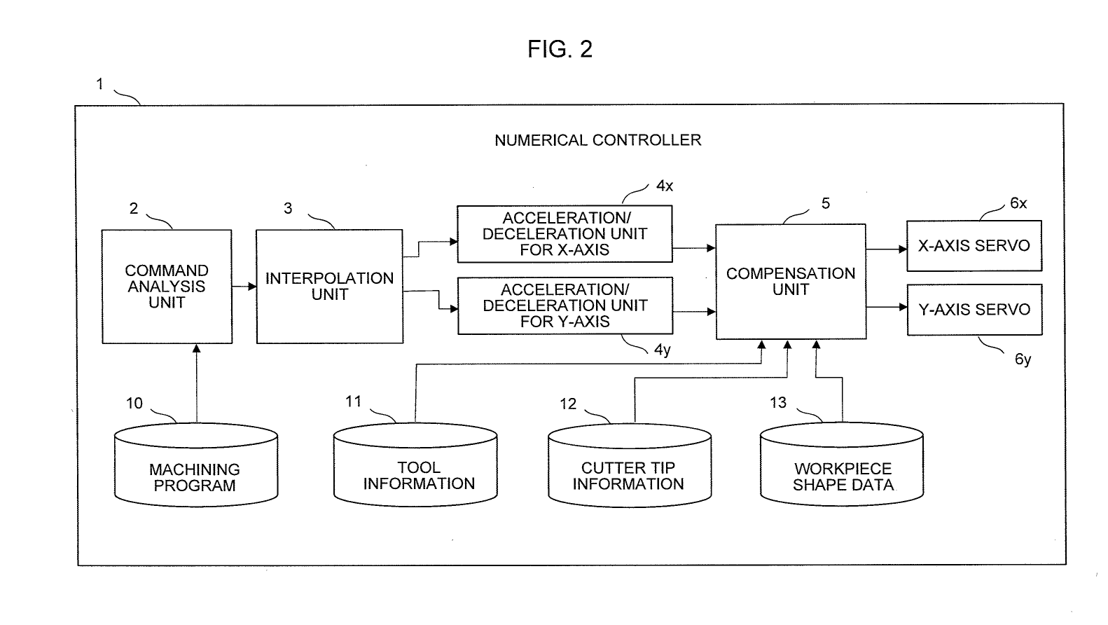

FIG. 2 is a schematic configuration diagram of the numerical controller according to the present embodiment. A numerical controller 1 of the present embodiment comprises a command analysis unit 2, interpolation unit 3, acceleration/deceleration units 4x and 4y for axes, compensation unit 5, and servos 6x and 6y for the axes.

The command analysis unit 2 analyzes blocks of a machining program 10 and generates data used for the movement of the axes. The interpolation unit 3 performs interpolation processing for the data output from the command analysis unit 2, thereby generating interpolation data based on interpolation calculation of points on a command path for each axis.

The acceleration/deceleration units 4x and 4y for the axes perform acceleration/deceleration processing based on the interpolation data generated by the interpolation unit 3, calculate speeds of the axes for each interpolation period, and output the resulting data to the compensation unit 5.

The compensation unit 5 performs compensation of the interpolation data using tool information 11, cutter tip information 12, and workpiece shape data 13 according to the procedure described later.

The servos 6x and 6y for the axes control servomotors for driving the axes of a machine based on the result of the interpolation by the compensation unit 5.

Configurations of a spindle control unit for rotation control of a spindle and the like are not shown in the drawings.

The following is a description of procedure of compensation of the tool center path performed by the compensation unit 5.

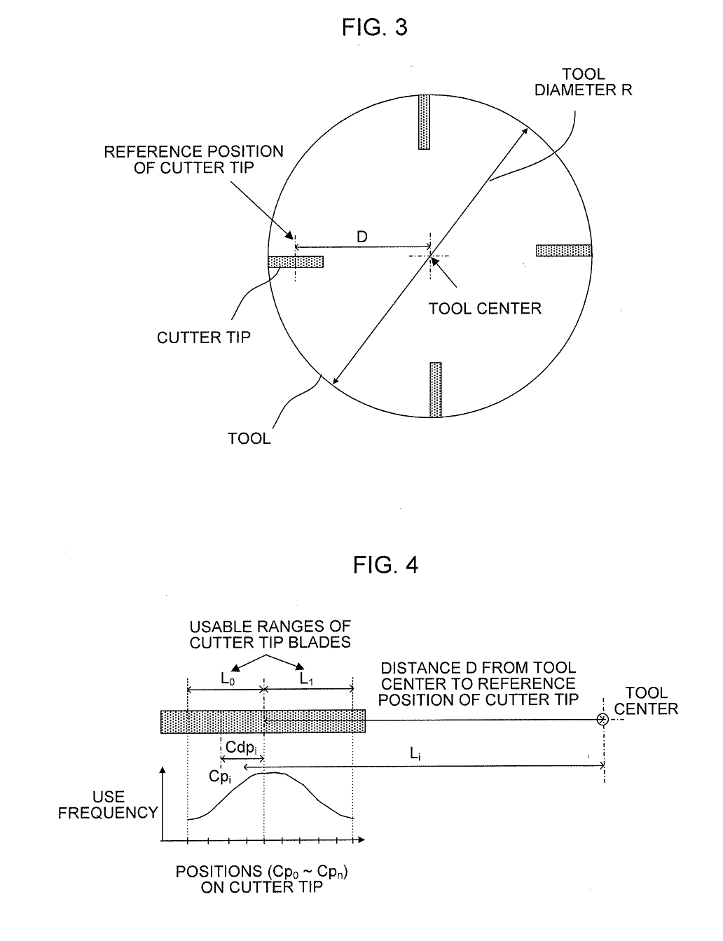

FIG. 3 is a diagram showing the tool with the cutter tip used for face milling. FIG. 4 is a schematic diagram showing the cutter tip of the tool. In the present embodiment, a tool diameter R, the diameter of the tool, and a distance D from the center of the tool to the reference position of the cutter tip are used as the tool information on the tool used for face milling. Further, usable ranges L₀ and L₁ of the cutter tip and a frequency of use in each position within the usable ranges (use frequency in a position Cpᵢ (i=0 to m) at a distance Cdpᵢ (i=0 to m) from the reference position of the cutter tip) are used as the cutter tip information of the tool.

The usable ranges L₀ and L₁ of the cutter tip are set in advance based on the specifications (material, hardness, shape, etc.) of the cutter tip. Further, the use frequency in each position within the usable ranges of the cutter tip is determined by the result of an endurance experiment previously conducted in each position on the cutter tip.

The tool information and the cutter tip information are input using input means of the numerical controller or the like and loaded into a memory of the numerical controller. Likewise, a machining program for specifying the tool center path and the workpiece shape data are input using the input means of the numerical controller or the like and loaded into the memory of the numerical controller.

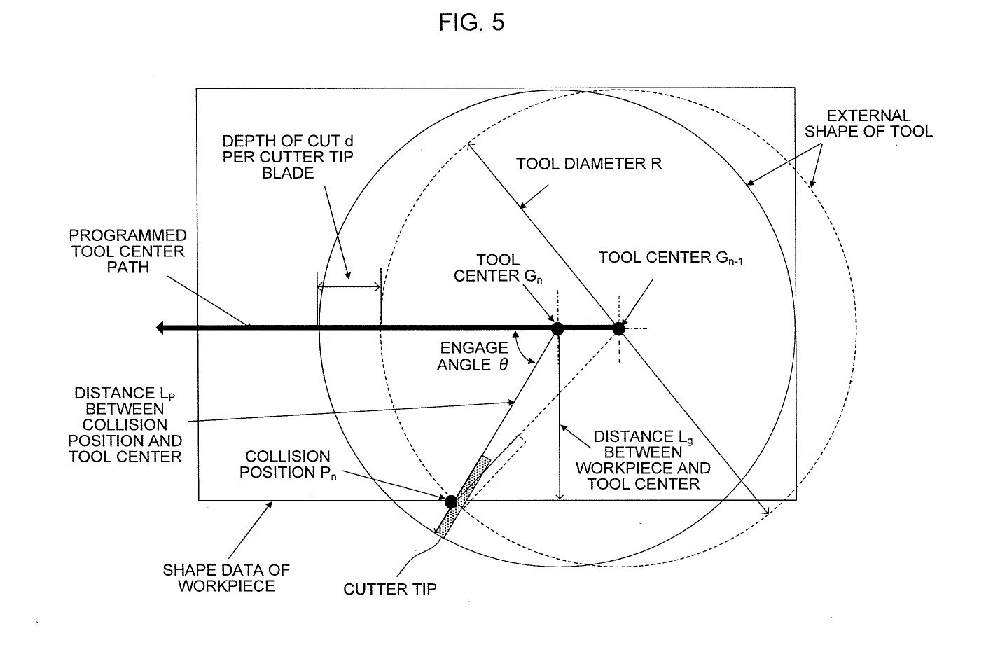

Then, in the face milling based on the machining program, the numerical controller of the present embodiment stored with the above-described information obtains a collision position Pₙ of the cutter tip and the workpiece corresponding to a tool center Gₙ, which is the point of intersection of the workpiece shape data and a circle (dotted-line circle in FIG. 5) with the tool diameter R about a tool center Gₙ₋₁ obtained from the programmed tool center path according to the machining program and is advanced by a margin corresponding to a depth of cut d per cutter tip blade, as shown in FIG. 5. An angle between an engaging edge of the workpiece and a line connecting the tool center Gₙ and the collision position Pₙ of the cutter tip is called an engage angle θ.

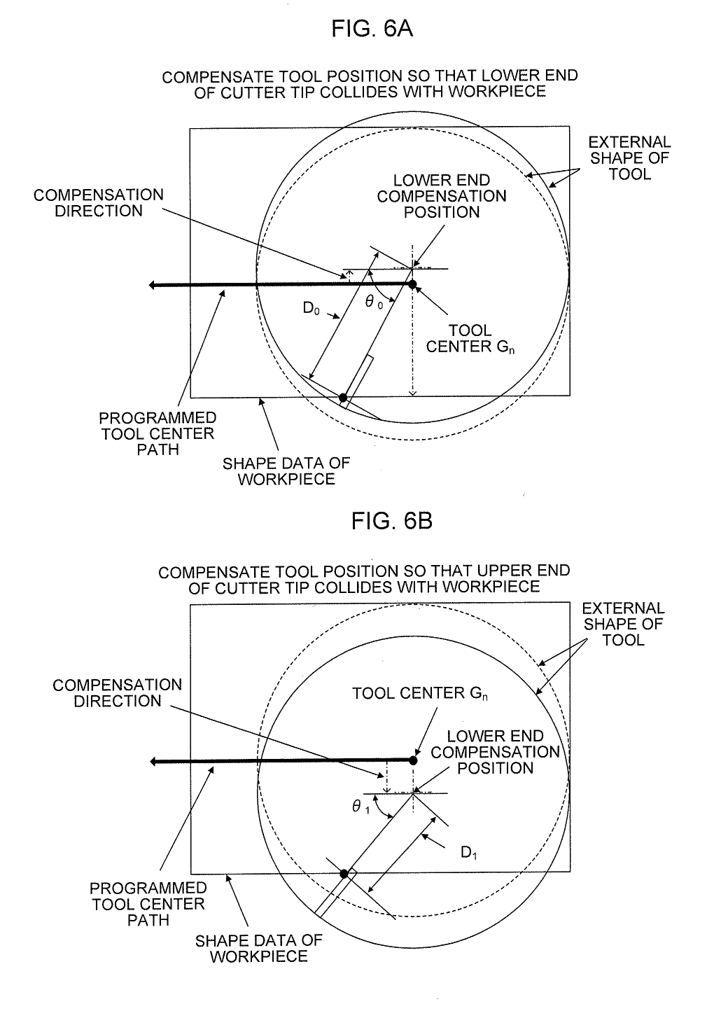

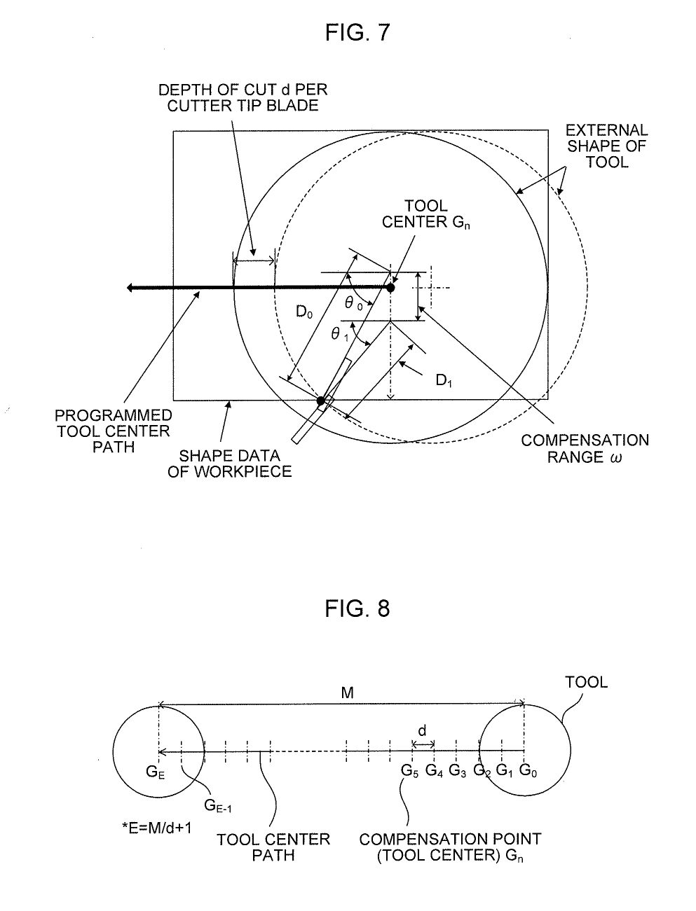

After the above-described calculation, the numerical controller of the present embodiment calculates parameters for a case in which a tool center position is compensated perpendicularly relative to the tool center path so as to collide with the lower end of the cutter tip (in a position at a distance (D+L₀) from the tool center position) and the workpiece, as shown in FIG. 6A, and a case in which the tool center position is compensated perpendicularly relative to the tool center path so as to collide with the upper end of the cutter tip (in a position at a distance (D−L₁) from the tool center position) and the workpiece, as shown in FIG. 6B. Based on the distance D from the tool center to the reference position of the cutter tip, which is included in the tool information, and the usable ranges L₀ and L₁ of the cutter tip, which are included in the cutter tip information, a compensation range ω is obtained using a distance D₀ (=D+L₀) of the lower end of each usable range of the cutter tip, distance D₁ (=D−L₁) of the upper end, engage angle θ₀ in the lower end position, and engage angle θ₁ at the upper end, as shown in FIG. 7.

The numerical controller compensates the tool center position perpendicularly relative to the tool path within the compensation range ω. When this compensation is performed, the frequencies of use within the usable ranges of the cutter tip and the positions on the cutter tip within the compensation range ω are associated with one another. Specifically, if use frequencies for positions Cp₀, Cp₁ and Cpₘ on the cutter tip are K₀, K₁ and Kₘ, respectively, the numerical controller generates the tool center path so that the ratio between frequencies of collision in positions Cp₀, Cp₁, . . . Cpₘ is K₀:K₁: . . . :Kₘ. Thus, the tool center path is compensated in the manner shown in FIG. 1.

Based on the collision frequency ratio (K₀:K₁: . . . :Kₘ) in the position Cpᵢ (i=0 to m) on the cutter tip, at this time, the numerical controller determines the position Cpᵢ on the cutter tip used for compensation at each compensation point (tool center Gₙ) shown in FIG. 8. The relationship between the distance Cdpᵢ of the position Cpᵢ on the cutter tip used for compensation at the determined tool center Gₙ from the reference position of the cutter tip and a distance Lₙ between the tool center Gₙ and the collision position of the tool cutter tip and the workpiece can be given as follows:

Lₙ=D+Cdpᵢ, (1)

where i is i=0, . . . , n.

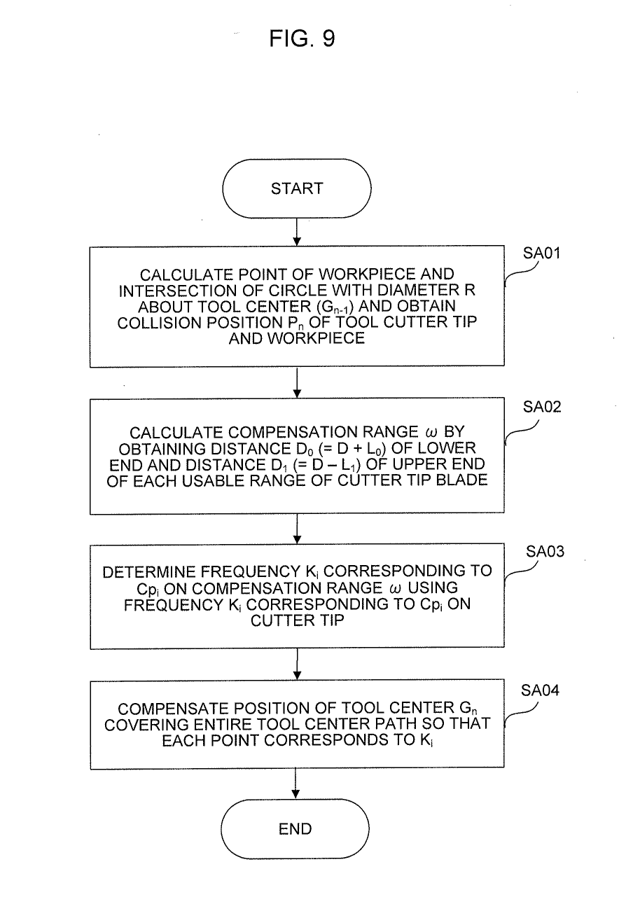

FIG. 9 is a flowchart showing processing performed on the numerical controller according to the present embodiment. It is assumed that the memory of the numerical controller is stored with the tool information, cutter tip information, machining program, and workpiece shape data before this processing is performed.
[Step SA01] The point of intersection of the workpiece and the circle with the tool diameter R about the tool center position Gₙ₋₁ is calculated using the data stored in the memory, whereby the collision position Pₙ of the tool cutter tip and the workpiece is obtained.
[Step SA02] Based on the data stored in the memory, the compensation range ω is calculated by obtaining the distance D₀ (=D+L₀) of the lower end and the distance D₁ (=D−L₁) of the upper end of each usable range of the cutter tip using the distance D from the tool center to the reference position of the cutter tip and the usable ranges L₀ and L₁ of the cutter tip in the cutter tip information.
[Step SA03] A frequency Kᵢ corresponding to the position Cpᵢ on the compensation range ω is determined using the frequency Kᵢ corresponding to the position Cpᵢ on the cutter tip stored in the memory.
[Step SA04] The position of the tool center Gₙ covering the entire tool center path is compensated so that each point within the compensation range ω corresponds to the frequency Kᵢ.

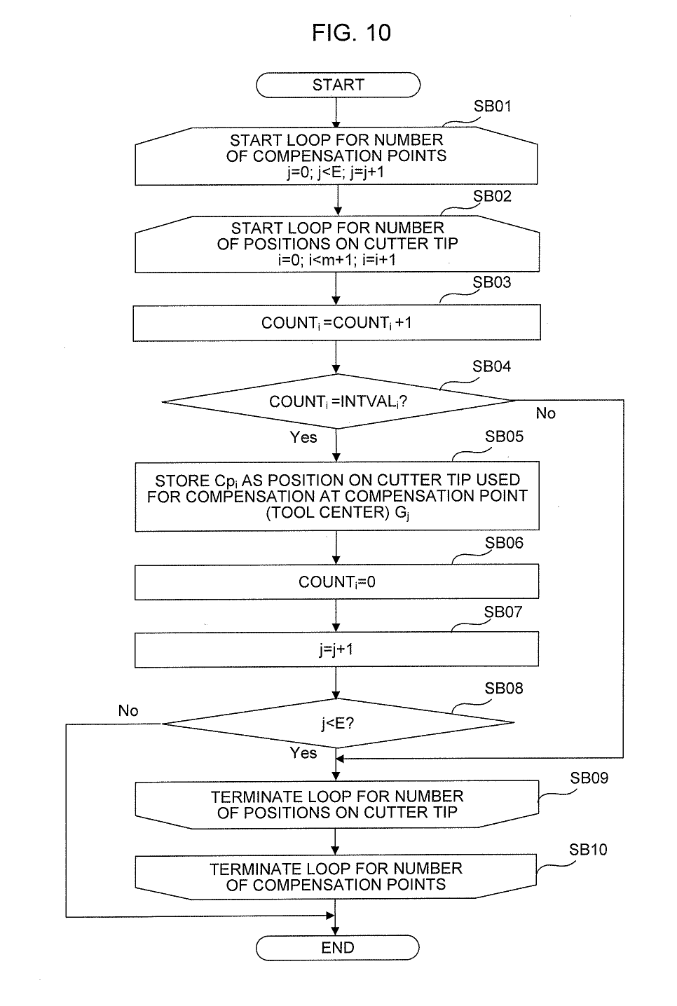

FIG. 10 is a flowchart showing processing for obtaining the position Cpᵢ on the cutter tip used for the compensation of the tool center Gₙ performed on the numerical controller according to the present embodiment. The position Cpᵢ on the cutter tip used for the compensation of the tool center Gₙ is determined with reference to the flowchart of FIG. 10. Based on a distance M between the start and end points of the tool center path shown in FIG. 8 and the depth of cut d per cutter tip blade, a total number E of compensation points (G₀ to Gₘ) on the tool center path is obtained from equation (2) as follows:

E=M/d+1. (2)

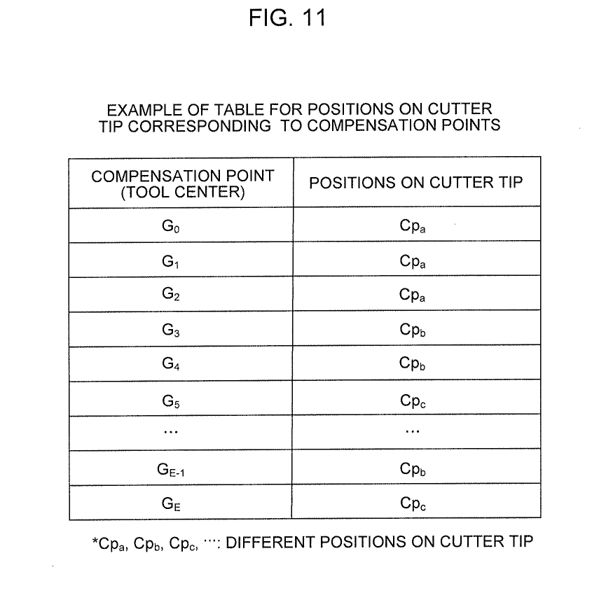

The compensation based on the position Cpᵢ on the cutter tip is performed (E×Kᵢ) times. An interval INTVALᵢ (shown in the flowchart of FIG. 10) for the compensation using the position Cpᵢ on the cutter tip on the tool center path is a number (reciprocal of the frequency Kᵢ) obtained by dividing the total number E of compensation points by the frequency (E×Kᵢ) of compensation.
[Step SB01] The processes of Steps SB02 to SB10 are repeated for the number of compensation points (tool centers).
[Step SB02] The processes of Steps SB03 to SB09 are repeated for the number of positions on the cutter tip.
[Step SB03] One is added to a counter COUNTᵢ for determining the interval for the use of the position Cpᵢ on the cutter tip, whereupon the counter is updated.
[Step SB04] The interval INTVALᵢ for the use of the position Cpᵢ on the cutter tip and COUNTᵢ are compared. If INTVALᵢ and COUNTᵢ are equal, the processing diverges to Step SB05. If INTVALᵢ and COUNTᵢ are not equal, the processing diverges to Step SB09.
[Step SB05] The position Cpᵢ is stored as a position on the cutter tip used for compensation at a tool center Gⱼ in the form of a table shown in FIG. 11 in the memory (not shown) of the numerical controller 1.
[Step SB06] Zero is set to the counter COUNTᵢ for determining the interval for the use of the position Cpᵢ on the cutter tip, whereupon the counter is cleared.
[Step SB07] One is added to a compensation point number loop counter j to update it.
[Step SB08] The compensation point number loop counter j and the total number E of compensation points on the tool center path are compared. If j is less than E, the processing diverges to Step SB09. If j is not less than E, the processing ends.
[Step SB09] One is added to a position number loop counter i to update it. If i is less than a total number (m+1) of the positions on the cutter tip, the processing diverges to Step SB02. If i is not less than (m+1), the processing diverges to Step SB10.
[Step SB10] One is added to the compensation point number loop counter j to update it. If j is less than the total number E of compensation points on the tool center path, the processing diverges to Step SB01. If j is not less than E, the processing ends.

In the case of the present embodiment, the engage angles θ₀ and θ₁ shown in FIGS. 6A and 6B are used as engage angle tolerances in place of the usable ranges L₀ and L₁ of the cutter tip and the use frequency in each position within the usable ranges.

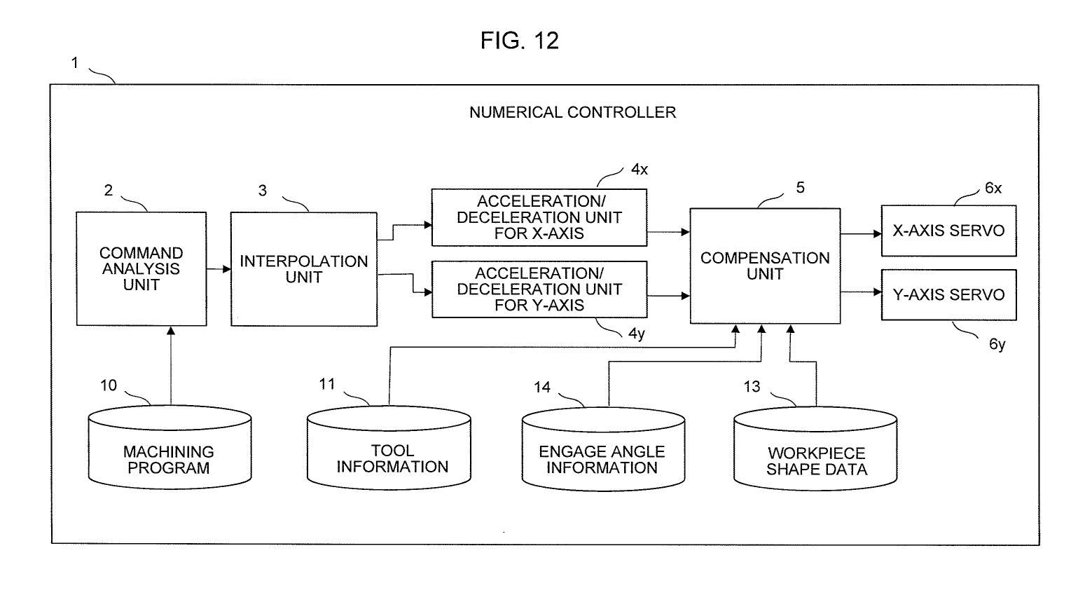

FIG. 12 is a schematic configuration diagram of a numerical controller according to the embodiment. A numerical controller 1 of the present embodiment differs from the foregoing embodiment in that engage information 14 including information on tolerances of engage angles and use frequencies at the engage angles is stored in place of the cutter tip information 12.

The tolerances of the engage angles are input using input means (not shown) or the like of the numerical controller 1 and stored in a memory (not shown) of the numerical controller 1. As this is done, moreover, the use frequencies at the engage angles within the tolerances of the engage angles are also accepted through the input means (not shown) or the like of the numerical controller 1 and stored in the memory (not shown) of the numerical controller 1. The use frequency at each engage angle within the usable ranges thereof is determined in advance by the result of an endurance experiment previously conducted for each engage angle of the cutter tip.

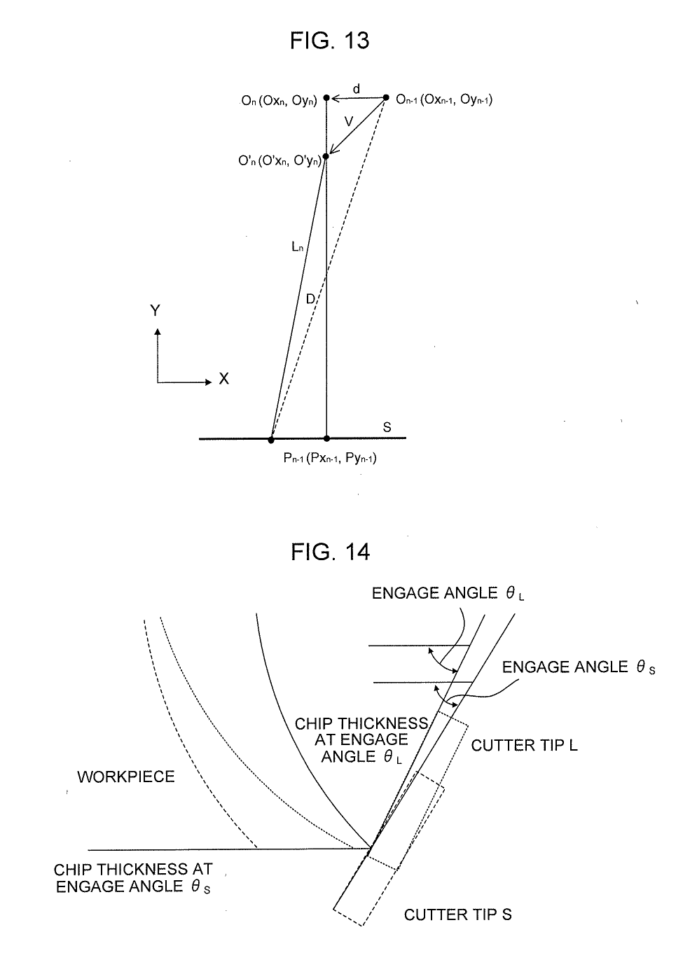

The numerical controller 1 obtains a compensation range ω based on the engage angles θ₀ and θ₁ and the distance between the tool center Gₙ and the collision position Pₙ. The numerical controller 1 compensates the tool center path within the compensation range ω. When this compensation is performed, the tolerances of the engage angles and the use frequencies for positions on the cutter tip preset depending on the properties of the cutter tip are associated with one another. Specifically, if use frequencies for engage angles θp₀, θp₁ and θpₘ are K₀, K₁ and Kₘ, respectively, the numerical controller 1 generates the tool center path so that the ratio between frequencies of collision at engage angles θp₀, θp₁, . . . θpₘ is K₀:K₁: . . . :Kₘ. If the distance between the tool center and the collision position of the cutter tip is then Lₙ, the nth collision position of the workpiece and the tool cutter tip is an intersection point position Pₙ₋₁(Pxₙ₋₁, Pyₙ₋₁) between the distance Lₙ from the tool center, contour S of the shape of the workpiece, and tool diameter D as the tool center position is moved by a feed amount d from Oₙ₋₁ to Oₙ, as shown in FIG. 13.

At this time, a compensation position O′ₙ(O′xₙ, O′yₙ) of the tool center can be obtained according to equation (3) as follows:

O′xₙ=Oxₙ,

O′yₙ=√Lₙ²−Pxₙ₋₁−Oxₙ)². (3)

In this way, the compensation unit 5 of the numerical controller 1 of the present embodiment performs compensation of the tool center path based on the engage information 14. Other operations are performed in the same manner as in the foregoing embodiment.

The present embodiment provides a method for further compensating the tool center path generated in the numerical controller 1.

In face milling, a large force may sometimes be produced due to unevenness of the workpiece as the tool cutter tip collides with the workpiece. FIG. 14 is a diagram illustrating engage angles and the thickness of chips of the workpiece produced when the tool cutter tip collides with the workpiece. A cutter tip L that collides with the workpiece at an engage angle θ_{L} is impacted less than a cutter tip S that collides with the workpiece at an engage angle θ_{S} is, due to the smaller thickness of chips produced at the time of the collision.

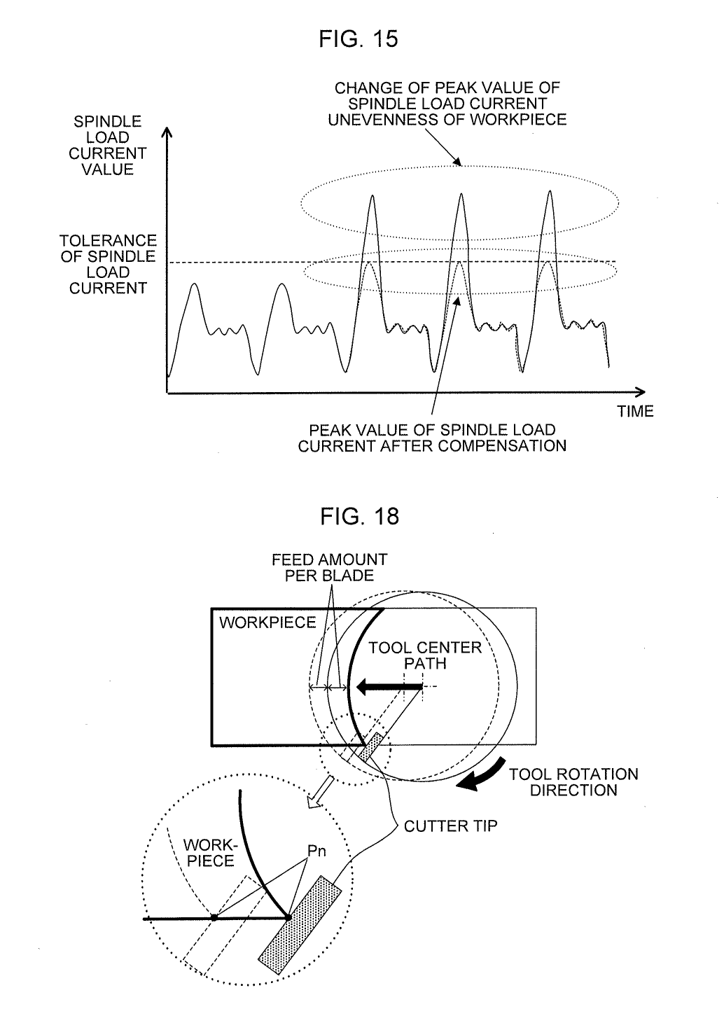

FIG. 15 shows the change of a peak value of a spindle load current due to unevenness of the workpiece. In the present embodiment, the tool center path is compensated so that the peak value of the spindle load current after the compensation is within a pre-specified tolerance of the value of the spindle load current.

According to the present embodiment, such a method is disclosed that the spindle load current value is monitored as the tool cutter tip collides with the workpiece. If the spindle load current value exceeds the pre-specified tolerance of the spindle load current, the tool center path is compensated so that the engage angle increases. Thus, the occurrence of chipping of the tool cutter tip can be suppressed by confining the force with which the tool cutter tip collides with the workpiece within the pre-specified tolerance of the spindle load current.

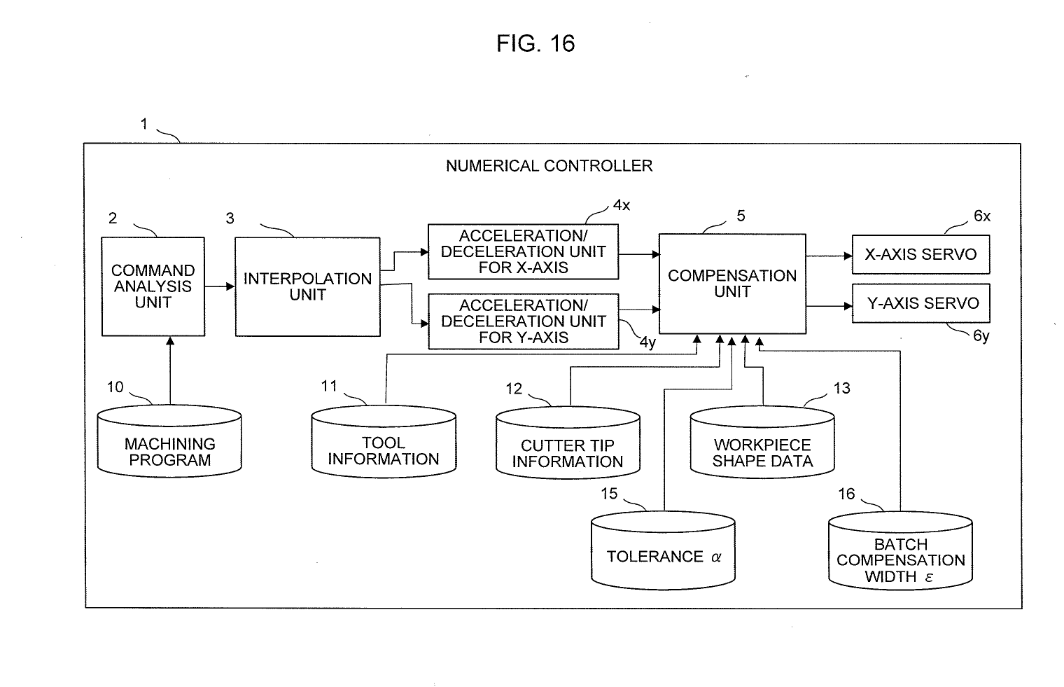

The numerical controller 1 of the present embodiment is designed so that a tolerance α of the spindle load current can be set by its input means (not shown) or the like. Also, the numerical controller 1 is designed so that a batch compensation width ε for the compensation of the tool center path can be set by its input means (not shown) or the like. The set tolerance α of the spindle load current and the batch compensation width ε for the compensation of the tool center path are loaded into the memory of the numerical controller (FIG. 16).

When the face milling based on the machining program is started, the numerical controller 1 of the present embodiment monitors the spindle load current value and acquires the peak value of the spindle load current that appears periodically. Also, an average γ of the peak value of the spindle load current within a pre-specified period is calculated. Then, the calculated average γ is compared with the tolerance α of the spindle load current. If the average γ exceeds the tolerance α, the tool center path is compensated for the batch compensation width ε. If an engage angle θₙ as a result of the compensation exceeds the engage angle θ₁ described in connection with the foregoing embodiment, however, the compensation is clamped at the engage angle θ₁. If the calculated average γ is within the tolerance α, in contrast, the compensation is canceled. The numerical controller 1 periodically repeats this compensation processing during actual machining.

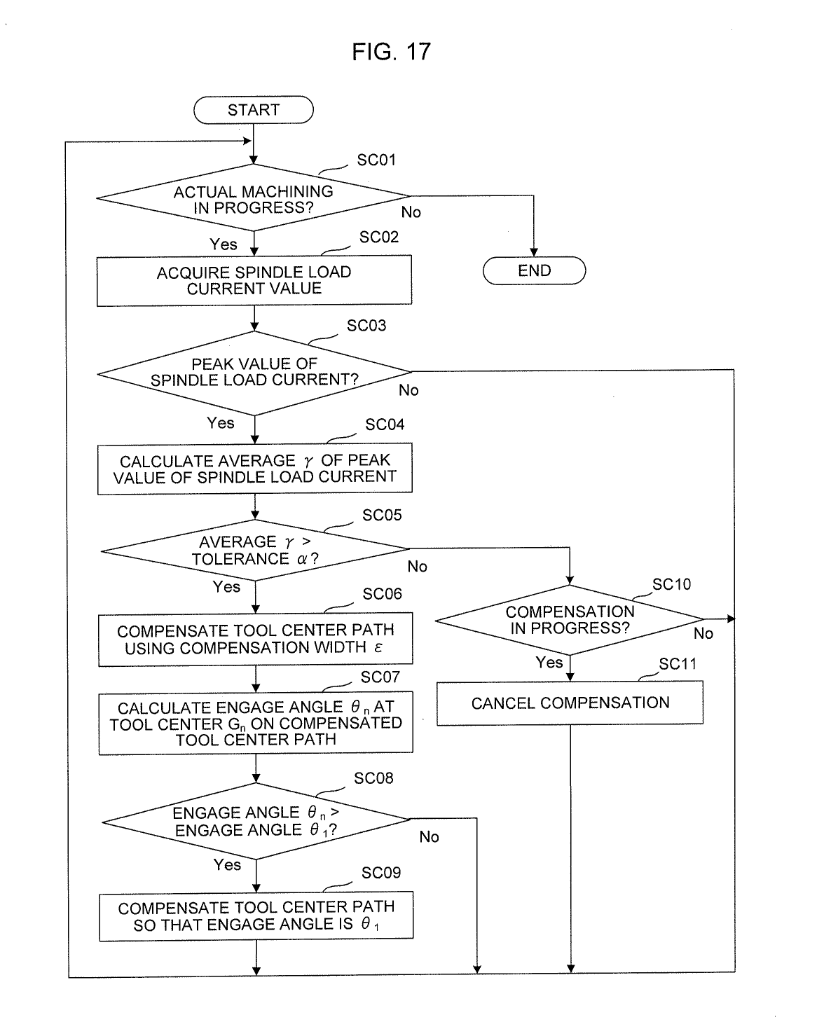

FIG. 17 is a flowchart showing processing performed on the numerical controller 1 according to the present embodiment. It is assumed that the memory (not shown) of the numerical controller is stored with the tolerance α of the spindle load current and the batch compensation width ε for the compensation of the tool center path.
[Step SC01] It is determined whether or not the actual machining is in progress. If the actual machining is in progress, the processing proceeds to Step SCO2. If not, this processing ends.
[Step SC02] The spindle load current value is acquired from an ammeter or the like attached to a power supply line for the spindle.
[Step SC03] It is determined whether or not the peak value of the spindle load current is acquired. If the peak value is acquired, the processing proceeds to Step SC04. If not, the processing returns to Step SC01.
[Step SC04] The average γ of the peak value of the spindle load current is calculated based on the peak value of the spindle load current acquired within the pre-specified period.
[Step SC05] It is determined whether or not the average γ of the peak value of the spindle load current is larger than the tolerance α. If the average γ of the peak value of the spindle load current is larger than the tolerance α, the processing proceeds to Step SC06. If not, the processing proceeds to Step SC10.
[Step SC06] The tool center path is compensated using the batch compensation width ε for the compensation of the tool center path.
[Step SC07] The engage angle θₙ in the position of the tool center Gₙ on the compensated tool center path is calculated.
[Step SC08] It is determined whether or not the engage angle θₙ is larger than the engage angle θ₁ at which the upper end of each usable range of the cutter tip collides with the workpiece. If the engage angle θₙ is larger than the engage angle θ₁, the processing proceeds to Step SC09. If not, the processing returns to Step SC01.
[Step SC09] The tool center path is compensated so that the engage angle is θ₁, whereupon the processing returns to Step SC01.
[Step SC10] It is determined whether or not the compensation is in progress. If the compensation is in progress, the processing proceeds to Step SC11. If not, the processing returns to Step SC01.
[Step SC11] The compensation in progress is canceled, whereupon the processing returns to Step SC01.

While embodiments of the present invention have been described herein, the invention is not limited to the above-described embodiments and may be suitably modified and embodied in various forms.

1. A numerical controller which controls a machine, which is configured so that a workpiece and a tool are relatively moved for machining by a drive mechanism and a spindle for rotating the tool, based on a machining program for specifying a movement path of the center of the tool, the numerical controller comprising:
a tool storage unit configured to store tool information including the diameter of the tool and the number of cutter tips attached to the tool;
a cutter tip information storage unit configured to store usable ranges of the cutter tips and use frequencies in positions within the usable ranges of the cutter tips;
a workpiece shape data storage unit configured to store workpiece shape data indicative of a shape of the workpiece; and
a compensation unit configured to generate a compensated tool path, which is a compensated version of the tool center path, so that the number of collisions with the workpiece in positions on the cutter tips complies with the use frequencies, based on the tool information, the tool center movement path specified by the machining program, the workpiece shape data, and the cutter tip information.

2. The numerical controller according to claim 1, further comprising an engage angle information storage means for storing engage angle information including usable ranges of engage angles at which the cutter tips collide with the workpiece and use frequencies at the engage angles within the usable ranges thereof, wherein the compensation unit is configured to generate a compensated tool path, which is a compensated version of the tool center path, so that the number of collisions with the workpiece at the engage angles of the cutter tips complies with the use frequencies, based on the tool information, the tool center movement path specified by the machining program, the workpiece shape data, and the engage angle information.

3. The numerical controller according to claim 1, comprising a spindle load current tolerance storage unit configured to store a spindle load current tolerance, which is a maximum allowable value of a spindle load current during cutting, wherein a spindle load current value during actual machining along a compensated tool path obtained by compensation by the compensation unit is acquired such that the spindle load current value and the spindle load current tolerance are compared and the compensated tool path is further compensated based on the result of the comparison.
